(19) United States
(12) Patent Application Publication
(10) Pub. No.: US 2023/0219038 A1
(43) Pub. Date: Jul. 13, 2023

(54) DRY GAS SCRUBBER

(71) Applicant: CSK INC., Yongin-si, Gyeonggi-do (KR)

(72) Inventors: JinHong Kim, Yongin-si, Gyeonggi-do (KR); MyungKeun Noh, Yongin-si, Gyeonggi-do (KR); Hyeon Yun Cho, Yongin-si, Gyeonggi-do (KR); SoLim Kang, Yongin-si, Gyeonggi-do (KR); JaeMyeong Choi, Yongin-si, Gyeonggi-do (KR)

(21) Appl. No.: 18/001,008

(22) PCT Filed: May 26, 2021
(86) PCT No.: PCT/IB2021/054565

§ 371 Date: Dec. 7, 2022

(30) Foreign Application Priority Data
Jun. 11, 2020 (GB) 2008863.9

(51) Int. Cl. B01D 53/81; B01D 53/04; B01D 53/26

(52) U.S. Cl. CPC B01D 53/81; B01D 53/266; B01D 53/0438; B01D 2258/0216

(57) ABSTRACT

A dry gas scrubber is disclosed. The dry gas scrubber is for treatment of an effluent stream and comprises: a chamber having an inlet for receiving the effluent stream, a cooler coupled with the inlet and configured to cool the effluent stream, and a resin chamber downstream of the cooler and configured to receive the effluent stream for treatment. In this way, the cooler is interposed between the process tool and the resin chamber and operates to cool the effluent stream prior to its being delivered to the resin chamber. Cooling the effluent stream in this way helps to improve the performance of the resin, even when the effluent stream is at an elevated temperature.

### CROSS-REFERENCE OF RELATED APPLICATION

This application is a Section 371 National Stage Application of International Application No. PCT/IB2021/054565, filed May 26, 2021, and published as WO 2021/250497 A1 on Dec. 16, 2021, the content of which is hereby incorporated by reference in its entirety and which claims priority of British Application No. 2008863.9, filed Jun. 11, 2020.

### FIELD

The field of the invention relates to a dry gas scrubber.

### BACKGROUND

Dry gas scrubbers are known. Dry gas scrubbers are used often in the processing of effluent streams from semiconductor processing tools. The dry gas scrubbers perform dry resin abatement abate gases that readily adsorb and react with material on the resin. Although such dry scrubbers exist, they each have their own shortcomings. Accordingly, it is desired to provide an improved dry gas scrubber.

The discussion above is merely provided for general background information and is not intended to be used as an aid in determining the scope of the claimed subject matter. The claimed subject matter is not limited to implementations that solve any or all disadvantages noted in the background.

### SUMMARY

According to a first aspect, there is provided a dry gas scrubber for treatment of an effluent stream, comprising: a chamber having an inlet for receiving the effluent stream, a cooler coupled with the inlet and configured to cool the effluent stream, and a resin chamber downstream of the cooler and configured to receive the effluent stream for treatment.

The first aspect recognizes that a problem with existing arrangements is that the effluent stream can arrive at the dry gas scrubber at an elevated temperature. That elevated temperature may damage or reduce the effectiveness of the dry gas scrubber. Accordingly, a dry gas scrubber may be provided. The scrubber may treat an effluent stream. The scrubber may comprise a chamber, housing or enclosure. The chamber may define or provide an inlet which receives the effluent stream to be treated. The chamber may have a cooler. The cooler may be coupled fluidly with the inlet. The cooler may be configured or arranged to cool the effluent stream. The chamber may have a resin chamber. The resin chamber may be located fluidly downstream of the cooler. The resin chamber may be configured to receive the effluent stream for treatment. In this way, the cooler is interposed between the process tool and the resin chamber and operates to cool the effluent stream prior to its being delivered to the resin chamber. Cooling the effluent stream in this way helps to improve the performance of the resin, even when the effluent stream is at an elevated temperature.

The chamber may comprise a powder trap downstream of the cooler and configured to filter the effluent stream, the resin chamber being downstream of the powder trap. Providing a powder trap helps to remove the presence of powder or particulate matter within the effluent stream which may condense in the effluent stream as it is cooled. Removing the powder from the cooled effluent stream helps to prevent the powder being conveyed into the resin chamber as this would otherwise tend to coat the surface of the resin and reduce its performance.

The cooler and the powder trap may be co-located concentrically. That is to say, the cooler and powder trap may share a common axis.

The cooler may surround the powder trap. This provides for a compact arrangement with the powder trap being nested within the cooler. Also, placing the cooler around the powder trap helps to improve the cooling performance of the cooler.

The cooler may comprise an annular chamber having an inner wall and an outer wall, the cooler being configured to convey the effluent stream circumferentially within the annular chamber from the inlet to a transfer port of the powder trap. Conveying the effluent stream circumferentially around the annular chamber helps to increase the distance travelled by the effluent stream when being conveyed from the inlet to the transfer port which helps to increase the amount of cooling on the effluent stream.

The inlet may be provided in the outer wall and the transfer port may be provided in the inner wall.

The inner wall may define a housing, enclosure or chamber of the powder trap. This provides for a shared wall arrangement which simplifies the construction of the scrubber and reduces its size.

The cooler may comprise cooling fins positioned to interrupt flow of the effluent stream within the annular chamber between the inlet and the transfer port. Interrupting the flow of the effluent stream helps to increase the dwell time of the effluent stream within the cooler and increases the flow distance between the inlet and the transfer port in order to increase the cooling effect of the cooler on the effluent stream.

The cooling fins may extend axially. Arranging the fins axially places them transverse to the direction of flow of the effluent stream to help deviate that flow within the annular chamber.

The cooling fins may extend radially between the inner wall and the outer wall. Accordingly, the cooling fins may provide a thermal path to the outer wall to help facilitate cooling.

The cooling fins may define one or more apertures to facilitate flow of the effluent stream circumferentially. Accordingly, the cooling fins may help to define sub-chambers within the annular chamber through which the effluent stream flows.

Adjacent apertures may be offset axially to encourage or facilitate a serpentine or zigzagged circumferential flow of the effluent stream. Again, this helps to increase the distance that the effluent stream must travel between the inlet and the transfer port in order to enhance cooling.

The powder trap may comprise at least one filter.

The powder trap may comprise a plurality of concentric or coaxially located filters. The filters may be nested within each other in order to provide a compact arrangement.

The concentric filters may be separated by annular plenums. The annular plenums may help collect condensed powder to reduce clogging of the filters.

An inner surface of an inner filter may define an inner plenum in fluid communication with the resin chamber.

The powder trap may be configured to encourage radial flow of the effluent stream from the transfer port to the inner plenum through the filters.

The powder trap may comprise a sump void configured to receive powder from the effluent stream. The sump void may be defined by a set of legs which elevate the filters above a floor of the powder trap and within which the powder may gather away from the filters.

The resin chamber may be stacked on the cooler. Again, this provides for a particularly compact arrangement.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 illustrates schematically the main components of a gas scrubber according to one embodiment;

FIG. 2 is a schematic diagram illustrating components of the cooler unit in more detail;

FIG. 3 schematically illustrates components of the cooler unit with the outer wall of the main canister removed;

FIG. 4 is a schematic drawing illustrating the main components of the powder trap in more detail;

FIG. 5 schematically illustrates a filter unit in more detail;

FIG. 6 illustrates flow paths within the gas scrubber; and

FIG. 7 illustrates a stacked resin chamber

### DETAILED DESCRIPTION

Before discussing the embodiments in any more detail, first an overview will be provided. Embodiments provide an abatement apparatus typically in the form of a dry gas scrubber of a dry resin abatement system which adsorbs specific compounds from an effluent stream of a semiconductor processing tool. A chamber is provided which receives the effluent stream to be treated and passes this through a cooler which cools the effluent stream prior to being conveyed to the resin chamber containing the resin. The cooler helps to rapidly cool the effluent stream provided by the process tool to a temperature more suited to the resin, which improves the performance of the resin. A powder trap may be also located with the cooler which helps to remove particulate matter within the effluent stream. The amount of particulate matter present in the effluent stream can increase due to such matter condensing during cooling. Providing a powder trap helps filter out that particulate matter and prevent it from settling on the surface of the resin, which further helps to improve the performance of the resin. Co-locating the cooler and the powder trap together with the resin chamber helps to provide a compact, high-performance arrangement.

### Dry Gas Scrubber

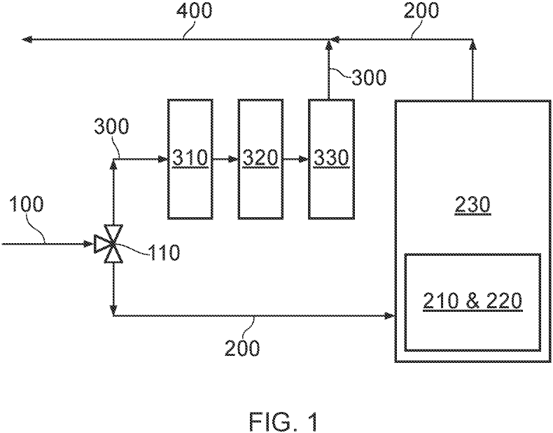

FIG. 1 illustrates schematically the main components of a gas scrubber according to one embodiment. The effluent stream is supplied to an inlet 100 and the supplied effluent stream is divided into a main process flow 200 and a bypass flow 300 under the control of a three-way valve 110. When operated with the main process flow 200, the effluent stream is supplied to a main canister 230. The effluent stream supplied to the main canister 230 is cooled by a cooler unit 210 installed below. The powder produced by the cooler unit 210 is collected by a powder trap 220 and the effluent stream moves to an upper resin chamber. The effluent stream is adsorbed by the resin inside and discharged to an outlet 400. To facilitate servicing of the main canister 230, the three-way valve can by operated to active the by-pass flow 300 where the gas is cooled by a cooler module 310. The powder contained in the cooled gas is then filtered by a filter module 320. Then, it is supplied to an auxiliary canister 330 for the adsorption treatment by the resin therein and discharged through the outlet 400.

### Cooler Unit

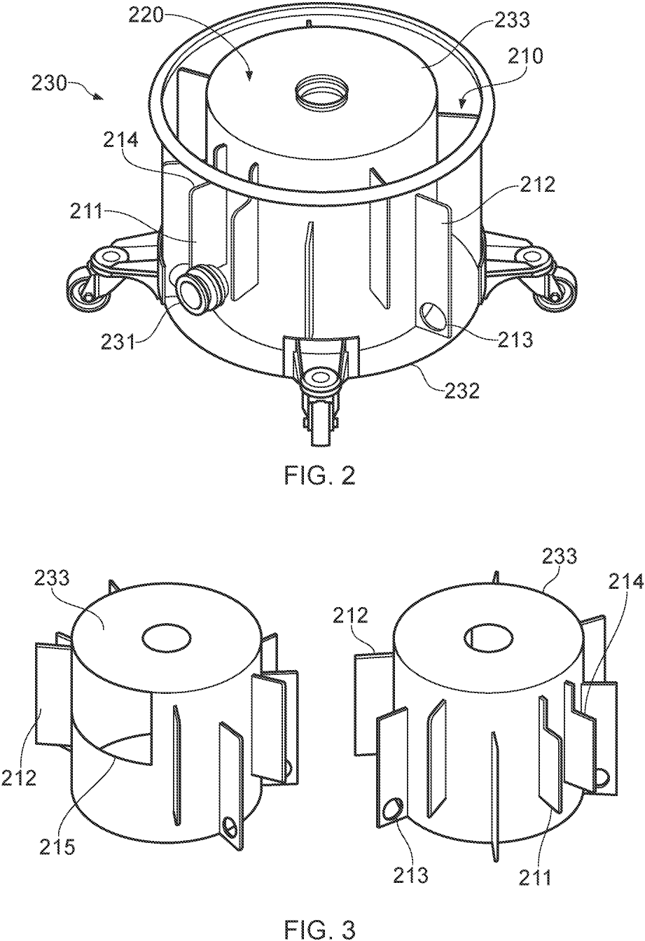

FIG. 2 is a schematic diagram illustrating components of the cooler unit 210 in more detail. FIG. 3 schematically illustrates components of the cooler unit 210 with the outer wall 232 of the main canister 230 removed. An inlet port 231 is provided which couples to the process line carrying the main process flow 200. The inlet port 231 is located in an outer wall 232 of the main canister 230. The cooler module 210 is an annular chamber defined by the outer wall 232 of the main canister 230 and an outer wall 233 of the powder trap 220. Cooling fins 212 extend axially along at least part of the annular chamber. The cooling fins 212 have apertures 213, recesses 214 and/or fail to completely extend along the axial length of the annular chamber in order to provide a fluid flow path circumferentially around the annular chamber. The power trap 220 is provided with a transfer port 215 which provides for fluid communication between the annular chamber and the powder trap 220.

### Powder Trap

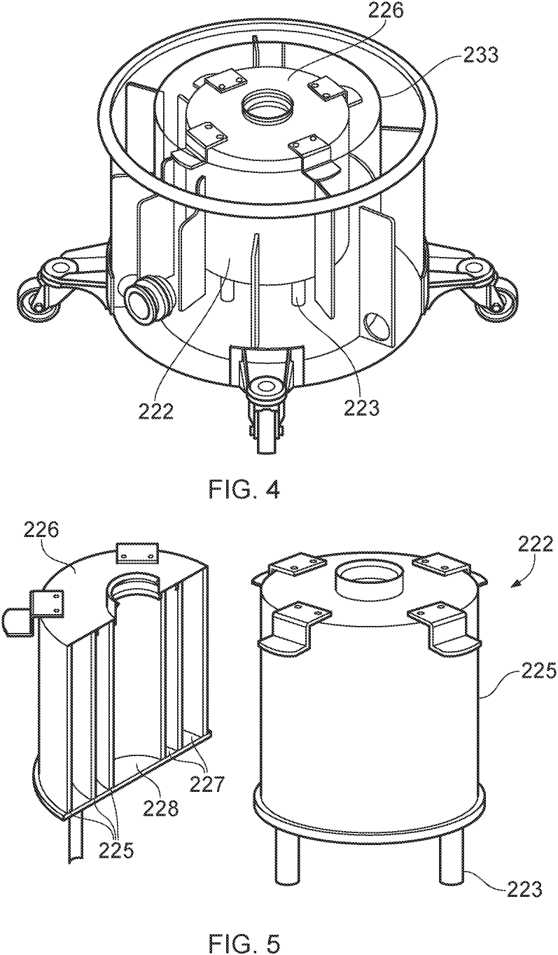

FIG. 4 is a schematic drawing illustrating the main components of the powder trap 220 in more detail. FIG. 5 schematically illustrates a filter unit in more detail. Filters are housed inside the outer wall 233 of the powder trap 220. In particular, within the powder trap 220 are three concentric filters 225 which together form a filter unit 222 having end plates 226, 227. In this example, the filters 225 are made of the same filter material. However, it will be appreciated that this need not be the case and that the filters 225 may be made of different filter material and may be of a differing number, depending on requirements. The filters 225 define plenums 227 therebetween. The filter unit 222 sits on three leg supports 223, which raises the filter unit 222 elevationally off the floor of the main canister 230. This provides a space for powder to collect, to extend the life of the powder trap 220. A central conduit 228 defines a plenum which is in fluid communication with a resin chamber mounted above.

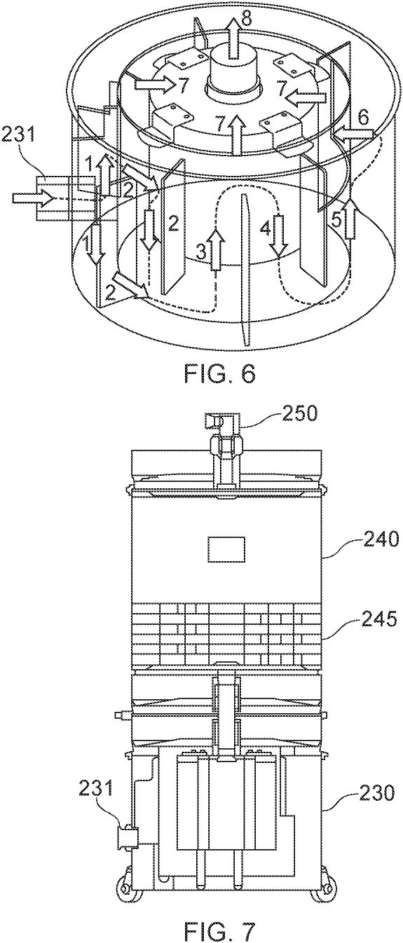

As can be seen in FIG. 6, in operation, an effluent stream typically at around 200° C. is received at the inlet port 231. The cooling fins 211 immediately adjacent the inlet port 231 help direct and split the flow of the effluent stream in the axial directions indicated by arrows 1 before further splitting the effluent stream and directing it in a circumferential direction around the annular chamber as indicated by the arrows 2. The cooling fins 211, 214, 215 and any apertures 213 help to direct the flow of the effluent stream to follow a serpentine path circumferentially around the annular chamber to the transfer port 215. The extended path caused by redirecting the flow of the effluent stream, together with the thermal conduction between the effluent stream, the powder trap housing 220, the main canister 230, the lower floor, the cooling fins 211, 214, 215 and the thermal paths between these components and the ambient atmosphere helps to cool the effluent stream to around 50° C. Hence, heat exchange is performed with the outer wall surface of the main canister 230 which is naturally cooled. The powder produced by the cooling is separated from the effluent stream by gravity and flow and is collected at the bottom of the annular chamber.

The effluent stream travels through the different filters 225 in a generally radial direction as indicated by the arrows 7. The effluent stream continues to cool and condensed particulate matter or powder is trapped by the filters 225. The effluent stream then passes into the central conduit 228 and travels axially into the base of the resin chamber as indicated by arrow 8. The temperature of the effluent stream has now reduced to generally below 50° C. and the majority of the particulate matter has been removed from the effluent stream prior to be delivered to the resin chamber.

### Resin Chamber

As shown in FIG. 7, the resin chamber 240 is stacked above the main canister 230. The effluent stream passes through a further filter 245, the resin and then exits through an outlet port 250.

Hence, it can be seen that some embodiments relate to a dry scrubber, and more particularly, to a dry scrubber including an apparatus for collecting powder contained in waste gas and gas cooling to increase the life and efficiency of resin. In some embodiments, a heat sink is installed inside the main canister in a process flow mainly for treating waste gas to lower the temperature of the gas, and has a space for collecting the powder generated from the cooled gas. The device may be equipped with one or more filters to prevent the movement of powder. The heat sink installed inside the main canister has a portion to fix the gas inlet portion and is supplied in a constant direction. The supplied gas stream generates two or more flow directions, resulting in lower airflow rates and increased heat exchange efficiency. In addition, it is easy to combine with and separate from a filter and has a function of fixing an installation position against external influences. Thereafter, the produced powder has a function of capturing the powder between the filter stages with a space between the filter stages in one or more stages to prevent movement to the resin layer. Another feature is to produce a modular form that allows cooling and powder collection during the bypass flow of the waste gas can be applied according to the use environment.

The cooling module is separated into a wall flow and a central flow of the supplied gas flow. The wall flow is cooled by the outer wall and mixed back with the central flow. Depending on the cooling performance, one or more modules can be installed. Three-way flow can be applied to select the flow direction to suit the environment. Some embodiments provide an energy-saving cooling device using heat exchange with a wall surface by controlling the flow of internal airflow without using a coolant such as cooling water, N2 or CDA in the gas cooling method.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A dry gas scrubber for treatment of an effluent stream, comprising:
a chamber having
an inlet for receiving said effluent stream,
a cooler coupled with said inlet and configured to cool said effluent stream, and
a resin chamber downstream of said cooler and configured to receive said effluent stream for treatment.

2. The dry gas scrubber of claim 1, wherein said chamber comprises a powder trap downstream of said cooler and configured to filter said effluent stream, said resin chamber being downstream of said powder trap.

3. The dry gas scrubber of claim 1, wherein said cooler and said powder trap are co-located concentrically and preferably said cooler surrounds said powder trap.

4. The dry gas scrubber of claim 1, wherein said cooler comprises an annular chamber having an inner wall and an outer wall, said cooler being configured to convey said effluent stream circumferentially within said annular chamber from said inlet to a transfer port of said powder trap.

5. The dry gas scrubber of claim 4, wherein said inlet is provided in said outer wall and said transfer port is provided in said inner wall.

6. The dry gas scrubber of claim 4, wherein said inner wall defines a housing of said powder trap.

7. The dry gas scrubber of claim 4, wherein said cooler comprises cooling fins positioned to interrupt flow of said effluent stream within said annular chamber between said inlet and said transfer port.

8. The dry gas scrubber of claim 4, wherein said cooling fins extend at least one of axially and radially between said inner wall and said outer wall.

9. The dry gas scrubber of claim 7, wherein said cooling fins define at least one aperture to facilitate flow of said effluent stream circumferentially.

10. The dry gas scrubber of claim 9, wherein adjacent apertures are offset axially to encourage a serpentine circumferential flow of said effluent stream.

11. The dry gas scrubber of claim 1, wherein said powder trap comprises a plurality of concentric filters and preferably each concentric filter is separated by an annular plenum.

12. The dry gas scrubber of claim 1, wherein an inner surface of an inner filter defines an inner plenum in fluid communication with said resin chamber.

13. The dry gas scrubber of claim 11, wherein said cooler comprises an annular chamber having an inner wall and an outer wall, said cooler being configured to convey said effluent stream circumferentially within said annular chamber from said inlet to a transfer port of said powder trap and wherein said powder trap is configured to encourage radial flow of said effluent stream from said transfer port to said inner plenum through said filters.

14. The dry gas scrubber of claim 1, wherein said powder trap comprises a sump void configured to receive powder from said effluent stream.

15. The dry gas scrubber of claim 1, wherein said resin chamber is stacked on said cooler.
